(19) United States
(12) Patent Application Publication
(10) Pub. No.: US 2023/0155498 A1
(43) Pub. Date: May 18, 2023

(54) CURRENT SOURCE CIRCUIT

(71) Applicant: ROHM CO., LTD., KYOTO (JP)

(72) Inventors: KOJI SAITO, KYOTO (JP); RYOICHI KUROKAWA, KYOTO (JP)

(21) Appl. No.: 17/985,281

(22) Filed: Nov. 11, 2022

(30) Foreign Application Priority Data
Nov. 16, 2021 (JP) 2021186400
Jul. 22, 2022 (JP) 2022117243

(51) Int. Cl. H02M 3/155

(52) U.S. Cl. CPC H02M 3/155

(57) ABSTRACT

The present disclosure provides a current source circuit. The current source circuit includes a constant current circuit and a current supply unit. The constant current circuit includes a first MOS transistor, a second MOS transistor and a first resistor. The first MOS transistor includes a source connectable to an applying end of a fixed voltage, a drain, and a gate that is shorted with the drain. The second MOS transistor includes a threshold voltage (Vₜₕ) lower than a threshold voltage of the first MOS transistor, and includes a gate connected to the gate of the first MOS transistor. The first resistor is connected between a source of the second MOS transistor and the source of the first MOS transistor. The current supply unit is configured to supply a current to the gate of the first MOS transistor.

### TECHNICAL FIELD

The present disclosure relates to a current source circuit.

### BACKGROUND

There are available conventional current source circuits capable of supplying a current to other circuit blocks. Such conventional current source circuit includes a constant current circuit, and a startup circuit for starting the constant current circuit (for example, referring to patent publication 1).

### PRIOR ART DOCUMENT

### Patent Publication

[Patent publication 1] Japan Patent Publication No. 2021-124742

### SUMMARY

### Problems to be Solved by the Present Disclosure

However, in the above current source circuit having a startup circuit, there is an issue of a prolonged time from inputting a power supply voltage to rising to a stable current.

In view of the issue above, it is an object of the present disclosure to provide a current source circuit capable of shortening a startup time.

### Technical Means for Solving the Problem

For example, a current source circuit of the present disclosure is configured to include: a constant current circuit; and a current supply unit, configured to supply a current to the gate of a first metal-oxide semiconductor (MOS) transistor; wherein the constant current circuit includes: the first MOS transistor, having a source connectable to an applying end of a fixed voltage, a drain, and a gate that is shorted with the drain; a second MOS transistor, having a threshold voltage lower than a threshold voltage of the first MOS transistor, and having a gate connected to the gate of the first MOS transistor; and a first resistor, connected between a source of the second MOS transistor and the source of the first MOS transistor.

### Effects of the Present Disclosure

The current source circuit according to the present disclosure is capable of shortening a startup time.

### BRIEF DESCRIPTION OF THE DRAWINGS

FIG. 1 is a diagram of a configuration of a current source circuit according to an exemplary embodiment of the present disclosure.

FIG. 2 is a circuit diagram of a current source circuit in a power-off state.

FIG. 3 is a circuit diagram of a current source circuit in a power-on state.

FIG. 4 is a diagram of an example of a longitudinal structure of an NMOS transistor in a constant current circuit.

FIG. 5 is a diagram of a configuration of a current source circuit of a variation example.

FIG. 6 is a diagram of a configuration of a constant current circuit of a variation example.

FIG. 7 is a diagram of a first configuration example of a current source circuit capable of performing temperature characteristics compensation.

FIG. 8 is a diagram of a second configuration example of a current source circuit capable of performing temperature characteristics compensation.

### DETAILED DESCRIPTION OF THE EMBODIMENTS

Details of the exemplary embodiments of the present disclosure are given with the accompanying drawings below.

### <1. Configuration of Current Source Circuit>

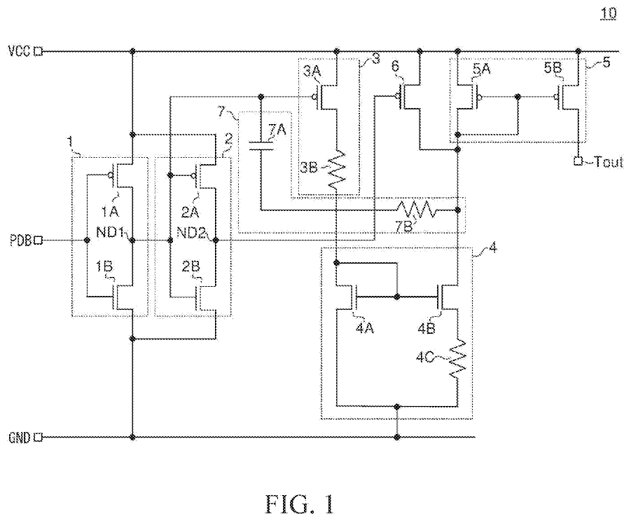

FIG. 1 shows a diagram of a configuration of a current source circuit 10 according to an exemplary embodiment of the present disclosure. The current source circuit 10 in FIG. 1 is a semiconductor integrated circuit including inverters 1 and 2, a current supply unit 3, a constant current circuit 4, an output current mirror 5, a p-channel metal-oxide-semiconductor field-effect transistor (PMOS transistor) 6 and a boost circuit 7 and integrating these constituent elements above.

The inverter 1 includes a PMOS transistor 1A and an n-channel metal-oxide-semiconductor field-effect transistor (NMOS transistor) 1B. A source of the PMOS transistor 1A is connected to an applying end of a power supply voltage applying terminal VCC. A drain of the PMOS transistor 1A is connected to a drain of the NMOS transistor 1B at a node ND1. A source of the NMOS transistor 1B is connected to an applying end of a ground potential. A power down signal PDB is applied to a gate of the PMOS transistor 1A and a gate of the NMOS transistor 1B. The power down signal PDB is a signal at a high level or a low level.

The inverter 2 includes a PMOS transistor 2A and an NMOS transistor 2B. A source of the PMOS transistor 2A is connected to the applying end of the power supply voltage applying terminal VCC. A drain of the PMOS transistor 2A is connected to a drain of the NMOS transistor 2B at a node ND2. A source of the NMOS transistor 2B is connected to the applying end of the ground potential. A gate of the PMOS transistor 2A and a gate of the NMOS transistor 2B are commonly connected at the node ND1.

Accordingly, the power down signal PDB is level inverted by the inverter 1, and is further level inverted by the inverter 2.

The power supply unit 3 is a circuit that supplies a current to a gate of an NMOS transistor 4A in the constant current circuit 4 to be described below, and includes a PMOS transistor 3A and a current supply resistor 3B.

The PMOS transistor 3A is a switch that switches on and off of a current supplied to the gate of the NMOS transistor 4A. A source of the PMOS transistor 3A is connected to the applying end of the power supply voltage applying terminal VCC. A drain of the PMOS transistor 3A is connected to a first end of the current supply resistor 3B. A gate of the PMOS transistor 3A is connected at the node ND1. Accordingly, a signal generated by level inverting by the inverter 1 based on the power down signal PDB switches on and off of the PMOS transistor 3A.

The constant current circuit 4 includes an NMOS transistor 4A, an NMOS transistor 4B and a constant current resistor 4C. A drain of the NMOS transistor 4A is connected to a second end of the current supply resistor 3B. A gate of the NMOS transistor 4A and a drain of the NMOS transistor 4A are shorted. A source of the NMOS transistor 4A is connected to the applying end of the ground potential. Gates of the NMOS transistors 4A and 4B are connected to each other. A source of the NMOS transistor 4B is connected to a first end of the constant current resistor 4C. A second end of the constant current resistor 4C is connected to the applying end of the ground potential.

When a current is supplied from the current supply unit 3 to the gate of the NMMOS transistor 4A, a constant current is generated in the constant current resistor 4C. Details for generating the constant current are to be described below.

The output current mirror 5 is a circuit that mirrors and outputs the constant current generated in the constant current circuit 4, and includes PMOS transistors 5A and 5B. A source of the PMOS transistor 5A on an input side is connected to the applying end of the power supply voltage applying terminal VCC. A gate of the PMOS transistor 5A and a drain of the PMOS transistor 5A are shorted. A drain of the PMOS transistor 5A is connected to a drain of the NMOS transistor 4B. Gates of the PMOS transistors 5A and 5B are connected to each other. A source of the PMOS transistor 5B is connected to the applying end of the power supply voltage applying terminal VCC. A drain of the PMOS transistor 5B is connected to an output terminal Tout used to output an output current.

A PMOS transistor 6 is a switch that switches between validity and invalidity of the PMOS transistors 5A and 5B in the output current mirror 5. A source of the PMOS transistor 6 is connected to the applying end of the power supply voltage applying terminal VCC. A drain of the PMOS transistor 6 is connected to a drain of the PMOS transistor 5A. A gate of the PMOS transistor 6 is connected to the node ND2. Accordingly, a signal from level inverting by the inverters 1 and 2 based on the power down signal PDB switches on and off of the PMOS transistor 6.

The boost circuit 7 is a circuit used to speed up the startup of the output current mirror 5, and includes a capacitor 7A and a boost resistor 7B. A first end of the capacitor 7A is connected to the node ND1. A second end of the capacitor 7A is connected to a first end of the boost resistor 7B. A second end of the boost resistor 7B is connected to the drain of the PMOS transistor 5A. That is to say, the capacitor 7A and the boost resistor 7B are connected in series.

### <2. Operation of Current Source Circuit>

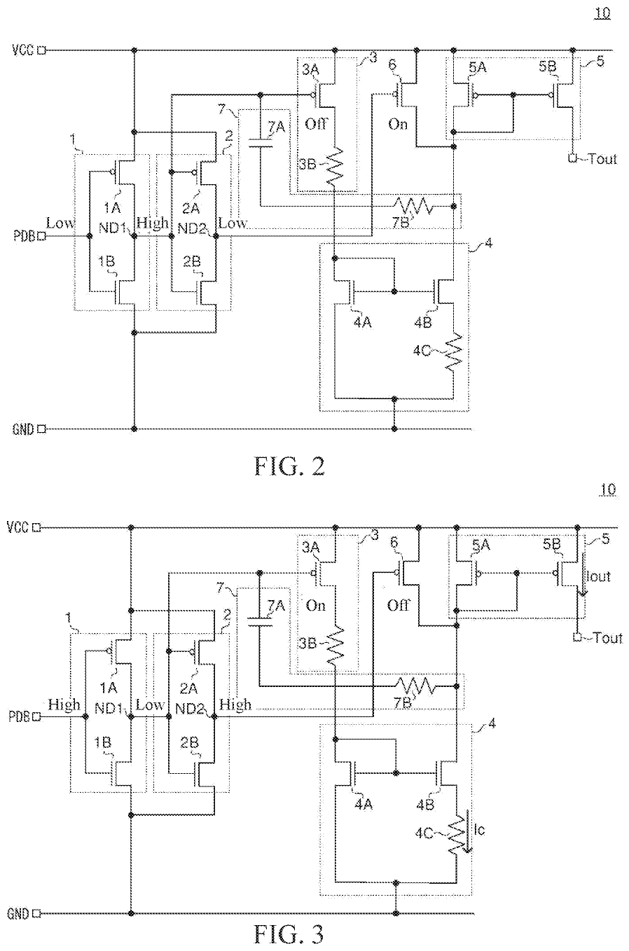

The operation of the current source circuit 10 in the above configuration is to be described with reference to FIG. 2 and FIG. 3 below.

FIG. 2 shows a circuit diagram of the current source circuit 10 in a power-off state. In the power-off state, the power down signal PDB is at a low level. Accordingly, a signal generated at the node ND1 by inverting the level of the power down signal PDB by the inverter 1 is at a high level. Thus, the PMOS transistor 3A is in an off state, and a current is not provided from the current supply unit 3 to the gate of the NMOS transistor 4A. At this point in time, a signal generated at the node ND2 by inverting the level of the signal generated at the node ND1 by the inverter 2 is at a low level. Accordingly, the PMOS transistor 6 becomes an on state. Thus, the gates of the PMOS transistors 5A and 5B are at a high level, and the PMOS transistors 5A and 5B are in an off state (invalid).

FIG. 3 shows a circuit diagram of the current source circuit 10 in a power-on state. In the power-on state, the power down signal PDB is at a high level. Accordingly, a signal generated at the node ND1 by inverting the level of the power down signal PDB by the inverter 1 is at a low level. Thus, the PMOS transistor 3A is in an on state, and a current is supplied from the current supply unit 3 to the gate of the NMOS transistor 4A.

Herein, the threshold voltage Vₜₕ of the NMOS transistor 4B is lower than the threshold voltage Vₜₕ of the NMOS transistor 4A. The potentials of the gates of the NMOS transistors 4A and 4B are common, and the constant current resistor 4C is connected between the source of the NMOS transistor 4B and the source of the NMOS transistor 4A. Thus, if a difference between the threshold voltages Vₜₕ of the NMOS transistors 4A and 4B is set to ΔVₜₕ, a constant current Ic=ΔVₜₕ/R (where R is a resistance vale of the constant current resistor 4C) is generated at the constant current resistor 4C.

At this point in time, a signal generated at the node ND2 by inverting the level of the signal generated at the node ND1 by the inverter 2 is at a high level. Accordingly, the PMOS transistor 6 becomes an off state. Thus, the PMOS transistors 5A and 5B in the output current mirror 5 are valid. Herein, because the low level signal generated at the node ND1 is applied to a first end of the capacitor 7A in the boost circuit 7, the gate voltages of the PMOS transistors 5A and 5B are lowered from the boost circuit 7. That is to say, the boost circuit 7 changes the gate voltages of the PMOS transistors 5A and 5B in the output current mirror 5 in a direction to turn on the PMOS transistors 5A and 5B. Accordingly, the constant current Ic generated in the constant current circuit 4 is mirrored by the output current mirror 5, and is used as an output current Tout output from the output terminal Tout. In addition, in the boost circuit 7, the changes in the gate voltages of the PMOS transistors 5A and 5B are buffered by the boost resistor 7B.

With the configuration of the constant current circuit 4 in this embodiment, without involving any startup circuit, the startup time from the power down signal PDB is switched from a low level to a high level to the output current Tout rises and reaches stabilization can be shortened. In addition, with the boost circuit 7 provided, the startup of the output current mirror 5 can be sped up, further shortening the startup time. Moreover, the circuit area can be reduced as no startup circuit is required.

### <3. Configuration of NMOS Transistor>

Herein, configuration examples of the NMOS transistors 4A and 4B in the constant current circuit 4 are described. FIG. 4 shows a diagram of an example of a longitudinal structure of the NMOS transistors 4A and 4B.

In the structure shown in FIG. 4, a buried layer (BL) 42 is formed on a P-type substrate 41. A P-well layer (HVPW) 43 is formed on the buried layer 42. On a surface portion of the P-well layer 43, an N+-type region 431 is formed on one lateral side, and an N+-type region 432 is formed on the other side. The N+-type region 431 is equivalent to a source region, and the N+-type region 432 is equivalent to a drain region. On a surface portion of the P-well layer 43, a trench region 433 is formed between the N+-type regions 431 and 432. A gate oxide film 44 is formed on the trench region 433. A gate electrode 45 is formed on the gate oxide film 44.

In both the NMOS transistors 4A and 4B, the gate electrode 45 is formed of P-type polysilicon or N-type polysilicon. In addition, the Fermi level of the gate can be made different according to a difference between doping amounts of the impurities in the gate electrode 45, thereby setting a difference between the threshold voltages Vₜₕ of the NMOS transistors 4A and 4B.

Alternatively, the gate electrode 45 of the NMOS transistor 4A may be formed of P-type polysilicon, and the gate electrode 45 of the NMOS transistor 4B may be formed of N-type polysilicon, such that the threshold voltage Vₜₕ of the NMOS transistor 4B is lower than the threshold voltage Vₜₕ of the NMOS transistor 4A.

### <4. Variation Example of Current Source Circuit>

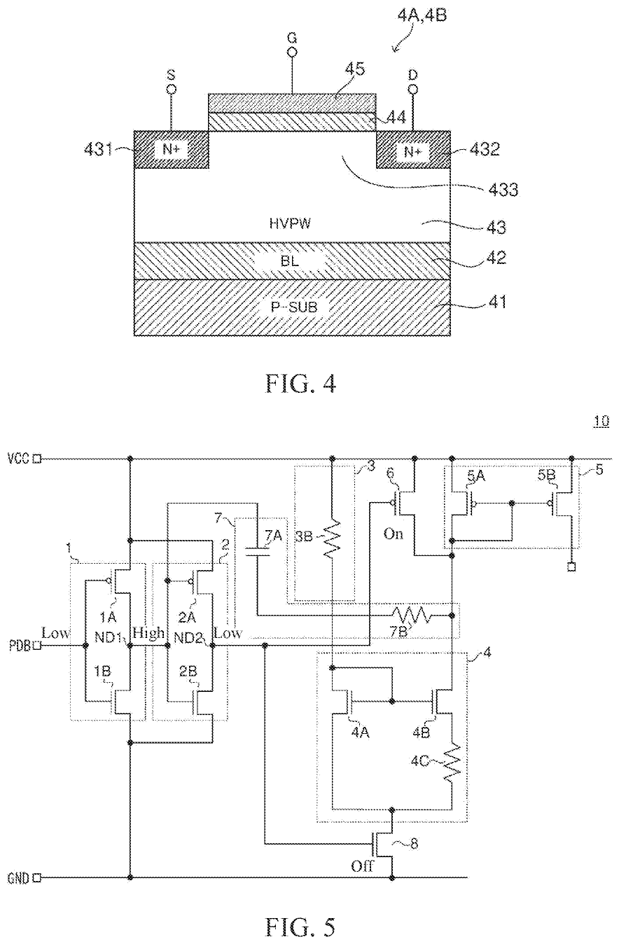

FIG. 5 shows a diagram of a variation example of the current source circuit 10. In the current source circuit 10 shown in FIG. 5, a power down switch 8 is provided in comparison with the embodiment (FIG. 1). In addition, accompanied with configuration of the power down switch 8, the PMOS transistor 3A is removed from the current supply unit 3.

The power down switch 8 is formed by an NMOS transistor. The source of the NMOS transistor 4A and the second end of the constant current resistor 4C are commonly connected to a drain of the power down switch 8. A source of the power down switch 8 is connected to the applying end of the ground potential. A gate of the power down switch 8 is connected to the node ND2.

According to the above configuration, as shown in FIG. 5, in a power-off state (in which the power down signal PDB is at a low level), the node ND2 is at a low level, and the power down switch 8 is in an off state. In the embodiment (FIG. 1), because the threshold voltage Vₜₕ of the NMOS transistor 4B is low, a leakage current may flow to the NMOS transistor 4B in a power-off state. In comparison, in this embodiment, because the power down switch 8 is in an off state, the leakage current can be blocked from flowing to the NMOS transistor 4B.

### <5. Variation Example of Constant Current Circuit>

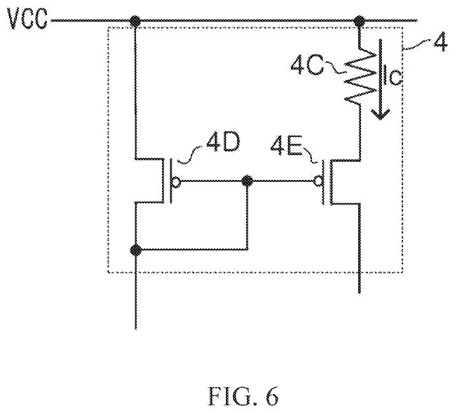

In the current source circuit, the constant current circuit 4 may also be implemented as the configuration shown in FIG. 6. The constant current circuit 4 in FIG. 6 includes PMOS transistors 4D and 4E. A source of the PMOS transistor 4D is connected to the applying end of the power supply voltage applying terminal VCC (fixed voltage). A gate of the PMOS transistor 4D and a drain of the PMOS transistor 4D are shorted. Gates of the PMOS transistors 4D and 4E are connected to each other. A source of the PMOS transistor 4E is connected to the first end of the constant current resistor 4C. The second end of the constant current resistor 4C is connected to the applying end of the power supply voltage applying terminal VCC.

The threshold voltage Vₜₕ of the PMOS transistor 4E is lower than the threshold voltage Vₜₕ of the PMOS transistor 4D. Accordingly, a difference between the threshold voltages Vₜₕ of the PMOS transistors 4D and 4E is used as ΔVₜₕ, and the constant current Ic=ΔVₜₕ/R is generated at the constant current resistor 4C.

### <6. Temperature Characteristics Compensation>

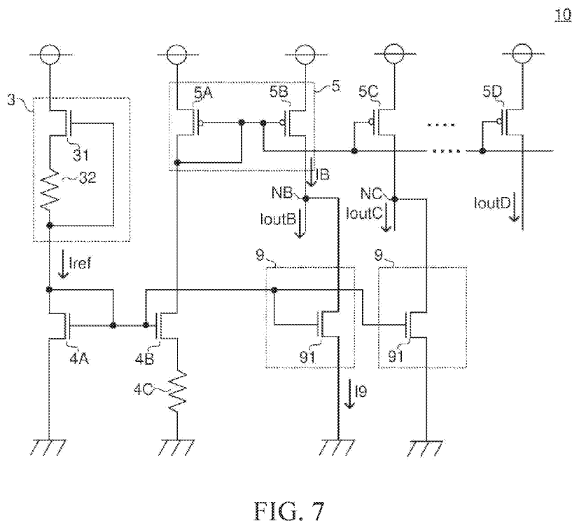

Herein, a current source circuit capable of performing temperature characteristics compensation is described. FIG. 7 shows a diagram of a first configuration example of the current source circuit 10 capable of performing temperature characteristics compensation.

In the current source circuit 10 shown in FIG. 7, the NMOS transistor 4A is composed of an enhancement-type MOSFET, and the NMOS transistor 4B is composed of a depletion-type MOSFET.

The current supply unit 3 is a constant current source including an NMOS transistor 31 composed of a depletion-type MOSFET and a bias resistor 32. A source of the NMOS transistor 31 is connected to a first end of the bias resistor 32. A second end of the bias resistor 32 is connected to a gate of the NMOS transistor 31. A second end of the bias resistor 32 is connected to the drain of the NMOS transistor 4A.

The drain of the PMOS transistor 5B in the output current mirror 5 is connected to a current source 9. The current source 9 includes an NMOS transistor 91. A drain of the NMOS transistor 91 is connected to the drain of the PMOS transistor 5B. A gate of the NMOS transistor 91 is connected to the gate of the NMOS transistor 4A. The current mirror is formed by the NMOS transistor 4A and the NMOS transistor 91.

Herein, a reference current Iref generated by the current supply unit 3 is set to have a positive temperature characteristic that increases as the temperature gets higher. In this case, a current IB that flows to the PMOS transistor 5B based on the reference current Iref has a positive temperature characteristic. Herein, a current I9 that flows through the current source 9 is based on the reference current Iref, and thus has a positive temperature characteristic. Thus, an output current IoutB output from a node NB at which the drain of the PMOS transistor 5B and the current source 9 are connected is generated by subtracting the current I9 from the current IB, and so the temperature characteristic is canceled to thereby inhibit a current change corresponding to the temperature.

In addition, in the configuration shown in FIG. 7, besides the PMOS transistor 5B as a PMOS transistor of which the gate and that of the PMOS transistor 5A are connected to each other, PMOS transistors 5C and 5D may be further provided. In the example in FIG. 7, a drain of the PMOS transistor 5C is connected to the current source 9, and the current source 9 is not provided for the PMOS transistor 5D. Accordingly, temperature compensation can be selectively performed on individual outputs by performing temperature compensation on the PMOS transistor 5C (output current IoutC) but not performing temperature compensation on the PMOS transistor 5D (output current IoutD).

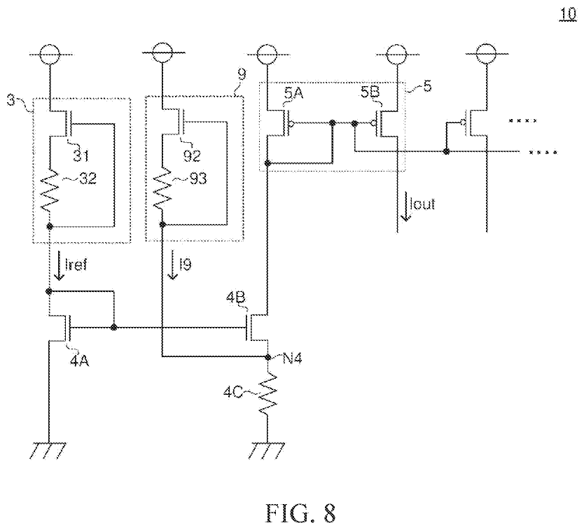

FIG. 8 shows a diagram of a second configuration example of the current source circuit 10 capable of performing temperature characteristics compensation. The configuration in FIG. 8 differs from the configuration in FIG. 7 in that, the current source 9 is connected to a node N4 at which the source of the NMOS transistor 4B and the constant current resistor 4C are connected, and the NMOS transistor 91 in FIG. 7 is not connected to the drain of the PMOS transistor 5B. In this configuration, the current source 9 has a configuration the same as that of the current supply unit 3, and includes an NMOS transistor 92 composed of a depletion-type MOSFET and a bias resistor 93. However, for example, a resistance value of the bias resistor 93 is adjusted such that the resistance value is different from that of the bias resistor 32.

Herein, the reference current Iref generated by the current supply unit 3 is set to have a positive temperature characteristic that increases as the temperature gets higher. In this case, the current I9 generated by the current source 9 is injected into the node N4, and the current I9 has a positive temperature characteristic. Accordingly, as the temperature gets higher, a gate-source voltage Vgs of the NMOS transistor 4B gets smaller, and the temperature characteristic of the current flowing to the NMOS transistor 4B is canceled. Thus, the output current Tout flowing to the PMOS transistor 5B can inhibit a current change corresponding to the temperature.

In addition, because the first configuration (FIG. 7) is configured to discard the amount of increase in the current IB due to temperature, the current consumption is large. However, with the second configuration (FIG. 8), the increase in the output current Iout is inhibited, and so the current consumption is small.

In addition, in either of the first and second configurations, if the reference current Iref has a negative temperature characteristic, the current I9 generated by the current source 9 has a negative temperature characteristic.

### <7. Other>

Further, in addition to the described embodiments, various modifications may be made to the technical features disclosed by the present disclosure without departing from the scope of the technical inventive subject thereof. That is to say, it should be understood that all aspects of the embodiments are illustrative rather than restrictive, and it should also be understood that the technical scope of the present disclosure is not limited to the embodiments, but includes all modifications that equal to meanings of the claims and fall within the scope of the claims.

### <8. Notes>

As described above, for example, a current source circuit (10) of the present disclosure is configured to include:

a constant current circuit (4); and

a current supply unit (3), configured to supply a current to a gate of a first metal-oxide-semiconductor (MOS) transistor; wherein the constant current circuit (4) includes:
the first MOS transistor (4A), having a source connectable to an applying end of a fixed voltage (GND), a drain, and a gate that is shorted with the drain;
a second MOS transistor (4B), having a threshold voltage (Vₜₕ) lower than a threshold voltage of the first MOS transistor, and having a gate connected to the gate of the first MOS transistor; and
a first resistor (4C), connected between a source of the second MOS transistor and the source of the first MOS transistor (first configuration).

In addition, the first configuration may be configured to further include:

an output current mirror (5), having an input side connected to the drain of the second MOS transistor (4B); and

a boost circuit (7), configured to change a gate voltage of a MOS transistor (5A, 5B) in the output current mirror in a direction to turn on the MOS transistor (second configuration).

In addition, the second configuration may be configured as, wherein the boost circuit (7) has a configuration in which a capacitor (7A) and a second resistor (3B) are connected in series (third configuration).

In addition, any one of the first to third configurations may be configured to further include a power down switch (8), the power down switch (8) including a first end commonly connectable to the source of the first MOS transistor (4A) and the first resistor (4C), and a second end connectable to the applying end of the fixed voltage (GND) (fourth configuration).

In addition, any one of the first to fourth configurations may be configured as, wherein both the first MOS transistor (4A) and the second MOS transistor (4B) are NMOS transistors, and the fixed voltage is a ground potential (fifth configuration).

In addition, the fifth configuration may be configured as, wherein the current supply unit (3) includes a switch element (3A) and a third resistor (3B) that are connectable in series between an applying end of a power supply voltage applying terminal applying terminal (VCC) and the drain of the first MOS transistor (4A) (sixth configuration).

In addition, any one of the first to sixth configurations may be configured as, wherein both a gate electrode of the first MOS transistor (4A) and a gate electrode of the second MOS transistor (4B) are formed of P-type polysilicon or N-type polysilicon, and a difference in threshold voltages (Vₜₕ) is provided between the first MOS transistor and the second MOS transistor by providing a difference in doping amounts of impurities in the gate electrodes (seventh configuration).

In addition, any one of the first to sixth configurations may be configured as, wherein a gate electrode of the first MOS transistor (4A) is formed of P-type polysilicon, and a gate electrode of the second MOS transistor (4B) is formed of N-type polysilicon (eighth configuration).

Further, the first configuration may also be configured to further include:

an output current mirror (5), having an input side connected to the drain of the second MOS transistor (4B); and

a current source (9), configured to generate a current having a temperature characteristic of a same polarity as a temperature characteristic of the current of the current supply unit (3),

wherein an output current is generated by subtracting the current generated by the current source from an output of the output current mirror (ninth configuration).

Further, the ninth configuration may also be configured to further include:

a plurality of output-side transistors (5B, 5C, 5D), having gates connected to a gate of an input-side transistor (5A) in the output current mirror (5),

wherein any one of the plurality of output-side transistors (5B, 5C) is configured corresponding to the current source (9), while any one of the plurality of output-side transistors (5D) is not configured corresponding to the current source (tenth configuration).

In addition, the ninth or tenth configuration may also be configured as, wherein the current source (9) includes a MOS transistor (91) having a gate connected to the gate of the first MOS transistor (4A) (eleventh configuration).

Further, the first configuration may also be configured to further include:

an output current mirror (5), having an input side connected to the drain of the second MOS transistor (4B); and

a current source (9), configured to generate a current having a temperature characteristic of a same polarity as a temperature characteristic of the current of the current supply unit (3),

wherein the current generated by the current source is injected into a node (N4) at which the source of the second MOS transistor and the first resistor (4C) are connected (twelfth configuration).

In addition, the twelfth configuration may also be configured as, wherein the current source (9) includes:

an NMOS transistor (92), composed of a depletion-type MOSFET; and

a bias resistor (93), having a first end connected to a source of the NMOS transistor and a second end connected to a gate of the NMOS transistor (thirteenth configuration).

In addition, any one of the first to thirteenth configurations may be configured as, wherein the first MOS transistor is composed of an enhancement-type MOSFET, and the second MOS transistor is composed of a depletion-type MOSFET (fourteenth configuration).

### INDUSTRIAL APPLICABILITY

The present disclosure may be used as a current source to supply a current to various circuits.

1. A current source circuit, comprising:
a constant current circuit, including:
a first MOS transistor, having a source connectable to an applying end of a fixed voltage, a drain, and a gate that is shorted with the drain;
a second MOS transistor, having a threshold voltage (Vₜₕ) lower than a threshold voltage of the first MOS transistor, and having a gate connected to the gate of the first MOS transistor; and
a first resistor, connected between a source of the second MOS transistor and the source of the first MOS transistor; and
a current supply unit, configured to supply a current to the gate of the first MOS transistor.

2. The current source circuit of claim 1, further comprising:
an output current mirror, having an input side connected to the drain of the second MOS transistor; and
a boost circuit, configured to change a gate voltage of a MOS transistor in the output current mirror in a direction to turn on the MOS transistor.

3. The current source circuit of claim 2, wherein the boost circuit has a configuration in which a capacitor and a second resistor are connected in series.

4. The current source circuit of claim 1, further comprising a power down switch, including:
a first end, commonly connectable to the source of the first MOS transistor and the first resistor; and
a second end, connectable to the applying end of the fixed voltage.

5. The current source circuit of claim 1, wherein both the first MOS transistor and the second MOS transistor are NMOS transistors, and the fixed voltage is a ground potential.

6. The current source circuit of claim 5, wherein the current supply unit includes a switch element and a third resistor that are connectable in series between a power supply voltage applying terminal and the drain of the first MOS transistor.

7. The current source circuit of claim 1, wherein
both a gate electrode of the first MOS transistor and a gate electrode of the second MOS transistor are formed of P-type polysilicon or N-type polysilicon, and
a difference in threshold voltages (Vₜₕ) is provided between the first MOS transistor and the second MOS transistor by providing a difference in doping amount of impurities in the gate electrodes.

8. The current source circuit of claim 1, wherein
a gate electrode of the first MOS transistor is formed of P-type polysilicon, and
a gate electrode of the second MOS transistor is formed of N-type polysilicon.

9. The current source circuit of claim 1, further comprising:
an output current mirror, having an input side connected to the drain of the second MOS transistor; and
a current source, configured to generate a current having a temperature characteristic of same polarity as a temperature characteristic of the current of the current supply unit, wherein
an output current is generated by subtracting the current generated by the current source from an output of the output current mirror.

10. The current source circuit of claim 9, further comprising:
a plurality of output-side transistors, having gates connected to a gate of an input-side transistor in the output current mirror, wherein
any one of the plurality of output-side transistors is configured corresponding to the current source, while any one of the plurality of output-side transistors is not configured corresponding to the current source.

11. The current source circuit of claim 9, wherein the current source includes a MOS transistor having a gate connected to the gate of the first MOS transistor.

12. The current source circuit of claim 10, wherein the current source includes a MOS transistor having a gate connected to the gate of the first MOS transistor.

13. The current source circuit of claim 1, further comprising:
an output current mirror, having an input side connected to the drain of the second MOS transistor; and
a current source, configured to generate a current having a temperature characteristic of same polarity as a temperature characteristic of the current of the current supply unit, wherein
the current generated by the current source is injected into a node at which the source of the second MOS transistor and the first resistor are connected.

14. The current source circuit of claim 13, wherein the current source includes:
an NMOS transistor, composed of a depletion-type MOSFET; and
a bias resistor, having a first end connected to a source of the NMOS transistor and a second end connected to a gate of the NMOS transistor.

15. The current source circuit of claim 1, wherein
the first MOS transistor is composed of an enhancement-type MOSFET, and
the second MOS transistor is composed of a depletion-type MOSFET.
